(19) United States
(12) Patent Application Publication
(10) Pub. No.: US 2026/0243197 A1
(43) Pub. Date: Aug. 20, 2026

(54) PROCESS FOR PRODUCING POWER IN A GAS TURBINE

(71) Applicant: JOHNSON MATTHEY DAVY TECHNOLOGIES LIMITED, London (GB)

(72) Inventors: Julie ASHCROFT, Royston Hertfordshire (GB); John David PACH, Billingham Cleveland (GB)

(21) Appl. No.: 18/870,224

(22) PCT Filed: May 23, 2023
(86) PCT No.: PCT/GB2023/051346

§ 371 Date: Nov. 27, 2024

(30) Foreign Application Priority Data
Jul. 21, 2022 (GB) 2210681.9

(51) Int. Cl. F02C 3/22; C01B 3/047; F02M 27/02

(52) U.S. Cl. CPC F02C 3/22; C01B 3/047; F02M 21/0206; C01B 2203/84; F02C 6/18; F02M 27/02

(57) ABSTRACT

A process for providing heat energy to an ammonia cracking reactor. The invention comprising recovering an oxygen containing off-gas from a hydrogen fueled gas turbine and supplying at least a portion of the off-gas to a fuel combustion zone to produce heat energy for the ammonia cracking reactor. The invention finds use in chemical production facilities, such as ammonia production facilities.

### FIELD OF THE INVENTION

The present invention relates to a process for cracking ammonia. More specifically the present invention relates to a process for providing heat to an ammonia cracking reactor. The present invention further relates to a method of revamping an ammonia plant with the process of the invention.

### BACKGROUND OF THE INVENTION

There is growing interest in the use of carbon free fuels to power gas turbine systems for the generation of carbon free electrical energy. Of such carbon free fuels, ammonia is of interest for carbon free electricity generation in ammonia production facilities, where a plentiful supply of ammonia exists. However, the development of ammonia fueled gas turbine systems is in its infancy. Many gas turbines which are commercially available are not supplied as being suitable for use with ammonia fuel.

A potential solution to using ammonia as a direct fuel is to crack ammonia to form a mixture of hydrogen and nitrogen, allowing a gas turbine to be driven by the combustion of the hydrogen.

The cracking of ammonia into hydrogen and nitrogen has been used for many years to provide hydrogen in ammonia plants to activate catalysts. The reaction may be depicted as follows:

$$2 {NH}_{3} ⇌ {N}_{2} + 3 {H}_{2}$$

The ammonia cracking reaction is endothermic and may usefully be achieved by passing ammonia over a suitable catalyst in externally heated catalyst-containing reaction tubes disposed in a furnace. Such furnaces are known, for example, for the steam reforming of natural gas or naphtha feedstocks.

Combusting hydrogen streams in gas turbines is known. US2022162999 and US2022162989 disclose processes comprising a gas turbine, driven by the combustion of a stream comprising hydrogen with a compressed air stream. The stream comprising hydrogen is produced in an ammonia cracker fed with an ammonia stream. The gas turbine is used to generate electrical and mechanical energy. Heat produced by the combustion of the stream comprising hydrogen is either supplied directly to the cracker or used to pre-heat the ammonia stream upstream of the cracker through a heat exchanger.

There remains a need to improve the efficiency of gas turbines driven by the combustion of carbon free fuels, in particular ammonia derived fuels.

### SUMMARY OF THE INVENTION

The present invention seeks to increase the energy efficiency of gas turbine systems which are driven by the combustion of carbon free fuels derived from the catalytic cracking of ammonia.

Accordingly, in a first aspect of the invention there is provided a process for generating power using a gas turbine fueled by a carbon free fuel derived from the catalytic cracking of ammonia, the process comprising:
supplying an ammonia stream to an ammonia cracking reactor;
cracking the ammonia in the ammonia stream in the ammonia cracking reactor to produce a hydrogen containing stream;
combining the hydrogen containing stream with an oxygen containing feed and combusting the hydrogen containing stream with the oxygen containing feed to produce a combusted gas stream;
using the combusted gas stream to drive a gas turbine and produce an oxygen containing off-gas stream;
supplying at least a portion of the oxygen containing off-gas stream to a fuel combustion zone; and
combusting a fuel stream and the oxygen containing off-gas stream in the fuel combustion zone to produce heat energy for the ammonia cracking reactor.

It has surprisingly been found that the off-gas stream from the gas turbine contains sufficient oxygen to be used for the combustion of a fuel stream in the fuel combustion zone. Moreover, the oxygen containing off-gas exits the gas turbine at an elevated temperature and therefore requires little or no pre-heating prior to combustion with the fuel stream. By supplying the heat energy produced from the combustion of the fuel stream and the oxygen containing off-gas to the ammonia cracking reactor in the process of the invention it has surprisingly been found that an unexpected energy saving can be realised.

It is a further advantage of the process of the invention that the cost of capital equipment may also be decreased. For instance, because at least a portion of the oxygen containing off-gas is used in the combustion of the fuel stream, less energy needs to be recovered from the remaining oxygen containing off-gas not used in the combustion of the fuel stream. This means smaller, hence cheaper, equipment (e.g. heat recovery equipment such as heat recovery steam generators) may be specified.

The gas turbine as described in the present invention may be referred to as an integrated gas turbine because the oxygen containing off-gas stream it produces is recovered and supplied to the fuel combustion zone. In contrast, reference to an unintegrated gas turbine includes processes where the oxygen containing off-gas stream generated from the gas turbine is not used for combustion.

The process of the invention is particularly suited to implementation in or nearby an ammonia production or storage facility where a supply of ammonia may provide an input to the ammonia cracking reactor to produce hydrogen gas in the hydrogen containing stream, and also as the fuel stream to be combusted with the oxygen-containing off-gas stream to provide heat to the ammonia cracking reactor. However, the process of the invention is not limited to implementation in an ammonia production facility and may be used in any appropriate setting where a supply of ammonia is available.

In another aspect of the invention there is provided a method of revamping an ammonia production facility by implementing the process of the first aspect of the invention in the ammonia production facility.

### BRIEF DESCRIPTION OF THE DRAWINGS

FIG. 1 shows a block flow diagram of a comparative process comprising an unintegrated gas turbine.

FIG. 2 shows a block flow diagram of a process of the invention comprising an integrated gas turbine.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The process of the invention comprises supplying an ammonia stream to an ammonia cracking reactor.

The ammonia stream may be derived from any source. In preferred processes of the invention, the ammonia stream is produced by the catalytic combination of hydrogen and nitrogen, for example the ammonia stream may be produced from a Haber-Bosch ammonia synthesis process. In preferred processes of the invention the ammonia stream may be produced in an ammonia production facility located upstream of the ammonia cracking reactor. Alternatively, the ammonia stream may be provided from an ammonia gas storage facility or ammonia gas pipeline.

In preferred processes of the invention the ammonia stream may be pre-heated prior to being supplied to the ammonia cracking reactor. Accordingly, the process of the invention may comprise the step of pre-heating the ammonia stream. The ammonia stream may be pre-heated to a temperature of greater than 350° C., greater than 400° C., greater than 450° C., greater than 500° C., or greater than 550° C. The ammonia stream may be pre-heated to a temperature of less than 1000° C., less than 950° C., less than 850° C., less than 750° C., or less than 700° C. The ammonia stream may be pre-heated to a temperature of from 350° C. to 1000° C., from 400° C. to 950° C., from 450° C. to 850° C., or from 500° C. to 750° C., such as from 550° C. to 700° C.

Suitable ammonia cracking reactors are known and may comprise a furnace box providing a radiant section comprising one or more burners to which a fuel stream and an oxygen feed gas, such as air, are fed. The radiant section comprises one or more catalyst-containing tubes though which the ammonia stream is passed. Combustion of the fuel stream in the one or more burners, creates radiant heat for heating the one or more reaction tubes, containing the ammonia cracking catalyst. There may be tens or hundreds of tubes in the radiant section. If desired, downstream of the radiant section the combustion gases may be used to pre-heat one or more feed streams in a convection section. Reactors comprising a radiant section containing reaction tubes and a convection for preheating feeds are known in steam methane reforming and may be applied to the present invention

Alternative ammonia cracking reactors may be used, e.g. where the combustion of the fuel in the fuel combustion zone is separate to the reactor comprising the catalyst containing tubes. Such a reactor is the compact reformer available from Johnson Matthey Davy Technologies Limited.

The catalyst may be any ammonia cracking catalyst. Nickel catalysts and ruthenium catalysts may be used. Preferred catalysts are nickel catalysts. The catalyst may comprise 3 to 30% by weight nickel, preferably 8 to 20% by weight nickel, expressed as NiO, on a suitable refractory support, such as alumina or a metal aluminate. The catalyst may be in the form of pelleted shaped units, which may comprise one or more through holes, or may be provided as a wash coat on a structured metal or ceramic catalyst. A particularly preferred catalyst is KATALCO® 27-2 available from Johnson Matthey PLC, which comprises 12% nickel, expressed as NiO, on a cylindrical pellet formed from a high surface area alumina support.

The process of the invention comprises the step of cracking the ammonia in the ammonia stream in the ammonia cracking reactor to produce a hydrogen containing stream.

The temperature of the ammonia stream at the inlet of the ammonia cracking reactor may be in the range of 350° C. to 1000° C., from 400° C. to 950° C., from 450° C. to 850° C., or from 500° C. to 750° C., such as from 550° C. to 700° C. The temperature of the hydrogen containing stream exiting the ammonia cracking reactor will influence the equilibrium position of the cracking reaction, and may be in the range of 500 to 950° C. Where nickel catalysts are used in the ammonia cracking reactor, the temperature of the hydrogen containing stream exiting the ammonia cracking reactor may preferably be greater than about 700° C.

The pressure inlet to the ammonia cracking reactor will be set by the flowsheet design and may be in the range 1 to 100 bar absolute, preferably 10 to 90 bar absolute, such as 31 to 51 bar absolute.

The ammonia cracking reaction produces a hydrogen containing stream which also contains nitrogen, and which may contain residual ammonia.

The hydrogen containing stream may comprise 40 mol % or more hydrogen, 50 mol % or more hydrogen, or 60 mol % or more hydrogen. The hydrogen containing stream may comprise 75 mol % or less hydrogen, 70 mol % or less hydrogen, or 65 mol % or less hydrogen. For example, the hydrogen containing stream may comprise from 40 mol % to 75 mol % hydrogen, from 50 mol % to 70 mol % hydrogen, or from 60 mol % to 65 mol % hydrogen.

The hydrogen containing stream may optionally be fed to a purification unit, such as a pressure swing absorption unit, to increase the hydrogen content by separating it from the other components. Accordingly, the process of the invention may comprise the step of feeding the hydrogen containing stream to a purification unit and increasing the hydrogen content of the hydrogen containing stream to produce a hydrogen-enriched stream and a tail gas.

The hydrogen-enriched stream may comprise 50 mol % or more hydrogen, 60 mol % or more hydrogen, or 75 mol % or more hydrogen. The hydrogen-enriched stream may comprise 100 mol % or less hydrogen, 90 mol % or less hydrogen, or 80 mol % or less hydrogen. For example, the hydrogen-enriched stream may comprise from 50 mol % to 100 mol % hydrogen, from 60 mol % to 90 mol % hydrogen, or from 70 mol % to 80 mol % hydrogen, such as about 75 mol % hydrogen.

The tail gas may comprise nitrogen with small amounts of ammonia and hydrogen. For instance, the tail gas may comprise nitrogen and from 1 mol % to 10 mol % ammonia (e.g. about 5 mol % ammonia or less), and from 2 mol % to 40 mol % hydrogen (e.g. from 15 mol % to 25 mol % hydrogen).

As used herein, the term “hydrogen containing stream” may be used to refer to either the hydrogen containing stream or the hydrogen-enriched stream.

The hydrogen containing stream may be fed to a steam generation unit and/or a heat recovery zone prior to combustion with the oxygen containing feed. As will be understood by the skilled person the steam generation unit and/or the heat recovery zone may be used to recover low or medium grade heat.

Separation of residual ammonia from the hydrogen containing stream is desirable before combustion of the hydrogen containing stream with the oxygen containing feed. Removal of ammonia may be accomplished by washing with water, for example using conventional scrubbing apparatus.

The process of the invention comprises the step of combining the hydrogen containing stream with an oxygen containing feed and combusting the hydrogen containing stream with the oxygen containing feed to produce a combusted gas stream.

The oxygen containing feed may be air, oxygen, or oxygen-enriched air. In preferred processes of the invention the oxygen containing feed is a compressed oxygen containing feed, for instance compressed air, compressed oxygen, or compressed oxygen-enriched air.

The process of the invention comprises the step of using the combusted gas stream to drive a gas turbine and produce an oxygen containing off-gas stream. The oxygen containing off-gas stream is therefore the exhaust gas from the gas turbine.

The process of the present invention may use any type of gas turbine The combustion of the hydrogen containing stream with the oxygen containing feed to produce the combusted gas stream may take place in a hydrogen combustion zone. The hydrogen combustion zone may be incorporated within the gas turbine or may be external to the gas turbine. Typically, the hydrogen combustion zone may be incorporated within the gas turbine.

Typically, in the process of the present invention the gas turbine and the ammonia cracking reactor are separate pieces of equipment.

The oxygen containing off-gas stream may have a temperature of from 500° C. to 800° C., from 500° C. to 750° C., or from 600° C. to 700° C., such as about 650° C.

The oxygen containing off-gas stream may comprise oxygen in an amount of greater than 5 mol %, greater than 8 mol %, greater than 11 mol %, or greater than 13 mol %. The oxygen containing off-gas stream may comprise oxygen in an amount less than 25 mol %, less than 22 mol % %, less than 20 mol %, or less than 18 mol %. For instance, the oxygen containing off-gas stream may comprise oxygen in an amount of from 5 mol % to 25 mol %, from 8 mol % to 22 mol %, from 11 mol % to 20 mol %, or from 13 mol % to 18 mol %, such as about 15 or about 16 mol %.

In preferred processes of the invention, the gas turbine may be used to produce power, for instance electrical power and/or mechanical power. The gas turbine may produce power directly or indirectly. For instance, the gas turbine may be coupled to any suitable generator for the creation of electrical power, and/or the gas turbine may be coupled to a compressor for the creation of mechanical power.

The process of the invention comprises the step of supplying at least a portion of the oxygen containing off-gas to a fuel combustion zone. The fuel combustion zone may be in or fluidly connected to the ammonia cracking reactor such that the combustion provides heat for the ammonia cracking reaction.

The fuel combustion zone may be within the ammonia cracking reactor or may be within a separate vessel for the combustion. The combustion of the fuel generates heat that is used to support the endothermic ammonia cracking reactions.

The fuel combustion zone may suitably be a radiant section in a furnace box of the ammonia cracking reactor. The fuel combustion zone may therefore provide heat energy (e.g. radiant heat) to the ammonia cracking reactor. Alternatively, if the fuel combustion zone is in a vessel separate from the ammonia cracking furnace, the ammonia cracking furnace may be of a heat exchange design, such as a gas-heated reformer or compact reformer, where catalyst-containing tubes are heated by convection from the hot combustion gas passing around the exterior surfaces of the tubes.

As will be readily understood, the fuel combustion zone functions to provide the heat energy required to catalytically crack the ammonia in the ammonia stream to produce the hydrogen containing stream.

The oxygen containing off-gas stream may be supplied to the fuel combustion zone at a temperature of from 500° C. to 800° C., from 500° C. to 750° C., or from 600° C. to 700° C., such as about 650° C.

The skilled person is able to calculate the portion of the oxygen containing off-gas stream which needs to be supplied to the fuel combustion zone. Typically, the portion of the oxygen containing off-gas stream supplied to the fuel combustion zone may be greater than 5%, greater than 7%, greater than 8% or greater than 9% of the total off-gas stream exiting the gas turbine. Typically, the portion of the oxygen containing off-gas stream supplied to the fuel combustion zone may be less than 75%, less than 50%, less than 30%, or less than 20% of the total off-gas stream exiting the gas turbine. For example, the portion of the oxygen containing off-gas stream supplied to the fuel combustion zone may be from 5% to 75%, from 7% to 50%, from 8% to 30%, or from 9% to 20% of the total off-gas stream exiting the gas turbine. For instance, it may be preferred that the portion of the oxygen containing off-gas stream supplied to the fuel combustion zone is from 10% to 15% or from 11% to 13% of the total off-gas stream exiting the gas turbine.

The process of the invention comprises the steps of combusting a fuel stream with the oxygen containing off-gas stream in the fuel combustion zone to produce heat energy for the ammonia cracking reactor.

The fuel stream used to provide the heat for the ammonia cracking reaction may be a carbon-free fuel stream. As used herein the term “carbon-free fuel stream” will be understood to include combustible compounds which do not contain carbon, for instance ammonia, and hydrogen. In preferred process of the invention the fuel stream comprises ammonia. The amount of ammonia in the fuel stream is not particularly limited, for instance the fuel stream may comprise ammonia in an amount of from 1 mol % to 100 mol % of the total fuel stream, such as from 5 mol % to 75 mol %, from 10 mol % to 50 mol %, or from 15 mol % to 30 mol % of the total fuel stream. Preferably, the fuel stream comprises ammonia in an amount greater than 10 mol %, greater than 12 mol %, or greater than 15 mol %. The fuel stream preferably comprises ammonia in an amount less than 45 mol %, less than 35 mol %, or less than 35 mol % of the total fuel stream. For instance, the fuel stream preferably comprises ammonia in an amount of from 10 mol % to 45 mol %, from 12 mol % to 35 mol %, or from 15 mol % to 25 mol % of the total fuel stream.

When the fuel stream comprises ammonia, the ammonia containing fuel stream may be supplied from the same or a different source as the ammonia stream being supplied to the ammonia cracking reactor. When the fuel stream comprises ammonia, the ammonia containing fuel stream is preferably supplied from the same source as the ammonia stream being supplied to the ammonia cracking reactor.

The fuel stream may comprise one or more additional fuel sources. The additional fuel sources are not necessarily carbon-free fuel sources, however, the additional fuel sources are preferably carbon-free fuel sources. The additional fuel sources may comprise one or more of hydrogen, natural gas, methane, refinery off gas, biogas, the tail gas from the hydrogen purification unit, or a portion of the hydrogen containing stream from the ammonia cracking reactor. As described above, preferred processes of the invention comprise a purification unit used to produce a hydrogen-enriched stream and a tail gas. In particularly preferred processes of the invention, the additional fuel source comprises the tail gas from the purification unit used to produce the hydrogen-enriched stream. Accordingly, in particularly preferred processes of the invention, the process comprises the step of feeding the hydrogen containing stream to a purification unit and increasing the hydrogen content of the hydrogen containing stream to produce a hydrogen-enriched stream and a tail gas; feeding the tail gas to the fuel combustion zone; and combusting the fuel stream and the tail gas with the oxygen containing off-gas.

It is an advantage of the present invention that the tail gas from the purification unit used to produce the hydrogen-enriched feed, and the fuel stream may be combusted with the oxygen containing off-gas. Using the tail gas in this fashion has been unexpectedly found to increase the overall efficiency of the process of the invention by maximising the amount of combustible fuel recovered from the process, and reducing losses of combustible and/or toxic chemicals (e.g. of ammonia) to atmosphere.

The additional fuel sources may be present in the fuel stream in any suitable amount providing that the fuel stream remains combustible with the oxygen containing off-gas stream.

In preferred processes of the invention the fuel stream is pre-heated prior to being combusted in the fuel combustion zone. The fuel stream may be pre-heated to any temperature below the auto ignition temperature of the fuel stream. For instance, the fuel stream may be pre-heated to a temperature greater than 100° C., greater than 150° C., or greater than 200° C. The fuel stream may be pre-heated to a temperature less than the auto ignition temperature of the fuel stream, such as less than 400° C., less than 350° C., or less than 300° C. For example, the fuel stream may be pre-heated to a temperature of from 100° C. to the auto ignition temperature of the fuel stream, such as from 100° C. to 400° C. In preferred processes of the invention the fuel stream is the ammonia containing fuel stream and is provided from the pre-heated ammonia stream.

The ratio of the fuel stream to the oxygen containing off-gas stream prior to combustion in the fuel combustion zone may be suitably chosen to allow efficient combustion of the fuel stream. The ratio of the fuel stream to the oxygen containing off-gas stream prior to combustion in the fuel combustion zone may depend upon the amount of oxygen present in the oxygen containing off-gas stream. For instance, where the fuel stream is pure ammonia and the oxygen containing off-gas comprises 13.2 mol % oxygen, the ratio of the fuel stream to the oxygen containing off-gas stream prior to the combustion in the fuel combustion zone may be selected to be in the range 1:6 to 1:7, such as 1:6.5.

It is preferred that the heat energy produced by combustion using the oxygen containing off-gas stream in the fuel combustion zone provides up to 100% of the heat energy required by the ammonia cracking reactor to crack the ammonia in the ammonia stream, for example up to 95%, up to 90%, up to 85%, or up to 80% of the heat energy required by the ammonia cracking reactor to crack the ammonia in the ammonia stream. It is preferred that the heat energy produced by combustion using the oxygen containing off-gas stream in the fuel combustion zone provides more than 50% of the heat energy required by the ammonia cracking reactor to crack the ammonia in the ammonia stream, for example more than 60%, more than 70% or more than 75% of the heat energy required by the ammonia cracking reactor to crack the ammonia in the ammonia stream. For instance, it is preferred that the heat energy produced by combustion using the oxygen containing off-gas stream in the fuel combustion zone provides more than 50% and up to 100% of the heat energy required by the ammonia cracking reactor.

Optionally, the process of the invention may comprise the step of passing a portion of the oxygen containing off-gas to a heat recovery zone, such as a heat recovery steam generator. If desired, any un-combusted ammonia or nitrogen oxides in the oxygen containing off-gas may be washed out or reacted out of the oxygen containing gas before it is passed to the fuel combustion zone.

The combustion in the fuel combustion zone generates a flue gas, which may be recovered from the ammonia cracking reactor. The flue gas may be cooled in one or more cooling stages and subjected to one or more purification stages before being discharged to atmosphere. The one or more cooling stages may include a preheating stage for one or more of the reactants for the ammonia cracking reactor and/or generating steam. The one or more purification stages may include a stage of selective catalytic reduction, or SCR, in which nitrogen oxides are reacted with ammonia to form nitrogen and water vapour. Any flue-gas selective catalytic reduction technology may be used.

In certain embodiments of the process of the invention the process comprises the steps of: supplying an ammonia stream to an ammonia cracking reactor;
cracking the ammonia in the ammonia stream in the ammonia cracking reactor to produce a hydrogen containing stream;
optionally feeding the hydrogen containing stream to a purification unit, such as a pressure swing absorption unit, and increasing the hydrogen content to produce a hydrogen-enriched stream and a tail gas;
optionally feeding the hydrogen-enriched stream to a steam generation unit and/or heat recovery zone;
combining the hydrogen-enriched stream with an oxygen containing feed and combusting the hydrogen-enriched stream with the oxygen containing feed to produce a combusted gas stream;
using the combusted gas stream to drive a gas turbine and produce an oxygen containing off-gas stream;
supplying at least a portion of the oxygen containing off-gas stream to a fuel combustion zone;
optionally supplying an additional fuel source to the fuel combustion zone; and
combusting a fuel stream, and the optional additional fuel source, with the oxygen containing off-gas stream in the fuel combustion zone to produce heat energy for the ammonia cracking reactor.

In certain embodiments of the process of the invention the process comprises the steps of:
supplying an ammonia stream to an ammonia cracking reactor;
cracking the ammonia in the ammonia stream in the ammonia cracking reactor to produce a hydrogen containing stream;
feeding the hydrogen containing stream to a purification unit, such as a pressure swing absorption unit, and increasing the hydrogen content to produce a hydrogen-enriched stream and a tail gas;
optionally feeding the hydrogen-enriched stream to a steam generation unit and/or heat recovery zone;
combining the hydrogen-enriched stream with an oxygen containing feed and combusting the hydrogen-enriched stream with the oxygen containing feed to produce a combusted gas stream;
using the combusted gas stream to drive a gas turbine and produce an oxygen containing off-gas stream;
supplying at least a portion of the oxygen containing off-gas stream to a fuel combustion zone;
optionally supplying an additional fuel source to the fuel combustion zone;
feeding the tail gas to the fuel combustion zone; and
combusting a fuel stream and the tail gas, and the optional additional fuel source, with the oxygen containing off-gas stream in the fuel combustion zone to produce heat energy for the ammonia cracking reactor.

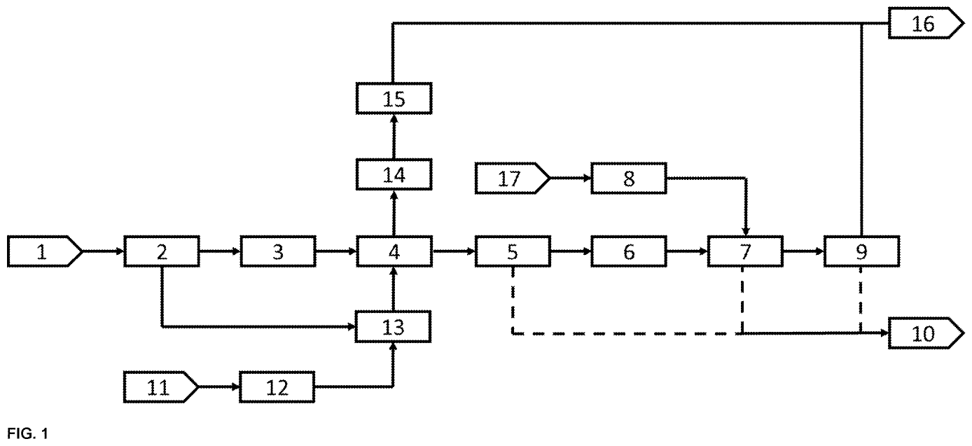

FIG. 1 illustrates a block flow diagram of a process not according to the invention comprising an unintegrated gas turbine. The block flow diagram of FIG. 1 shows ammonia (1) being fed to an ammonia pre-heat & vaporisation zone (2) outside of the ammonia cracking reactor where the ammonia is vaporised. The pre-heated and vaporised ammonia is fed to an ammonia superheating zone (3) and a cracker combustion zone (13). In the block flow diagram of FIG. 1 the ammonia cracking reactor (4), the ammonia superheating zone (3), and the cracker combustion zone (13) are all part of the same piece of equipment. Ammonia from the ammonia superheating zone (3) is fed to an ammonia cracking reactor (4) to produce a hydrogen containing stream. The hydrogen containing stream is fed to a steam generator (5) and to a heat recovery zone (6). The hydrogen containing stream from the heat recovery zone (6) is fed to a gas turbine (7) where it is combusted in the presence of an oxygen containing feed which is air (17) which has been compressed by a compressor (8). Steam from the steam generator (5) and off-gas from the gas turbine (7) are used to generate electrical power (10). Heat from the off-gas from the gas turbine (5) is recovered by a heat recovery steam generator (9). In the fuel combustion zone (13) ammonia fuel is combined with pre-heated air from an air pre-heating zone (12). The ammonia fuel and pre-heated air are combusted in the fuel combustion zone (13) to produce heat energy for the ammonia cracking reactor (4). Exhaust gas from the ammonia cracking reactor (4) is recovered in the heat recovery zone (14) and the exhaust gas sent to the stack (15) to be discharged as flue gas (16). Heat from the heat recovery zone (14) is used in the ammonia pre-heat & vaporisation zone (2) and the air pre-heating zone (12) (not shown for clarity). One or more process streams may be heated in exchange with exhaust gas in the heat recovery zone (14).

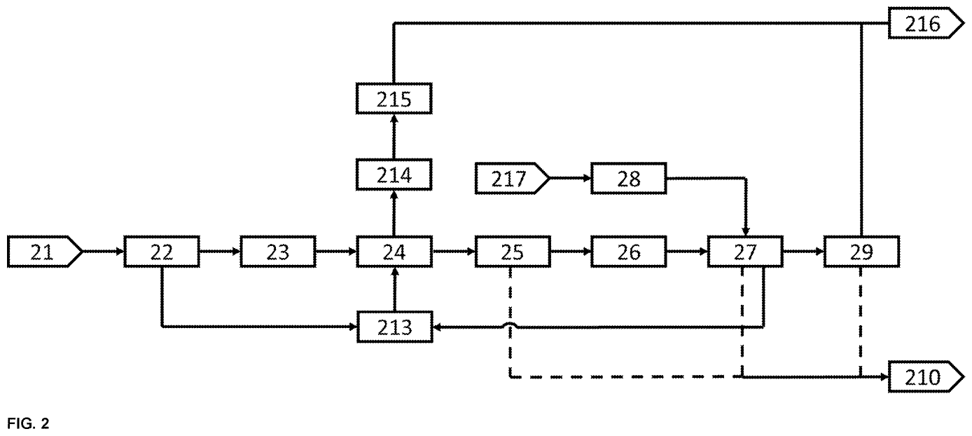

FIG. 2 illustrates a block flow diagram of a process according to the invention comprising an integrated gas turbine. The block flow diagram of FIG. 2 shows ammonia (21) being fed to an ammonia pre-heat & vaporisation zone (22) outside of the ammonia cracking reactor where the ammonia is vaporised. The pre-heated and vaporised ammonia is fed to an ammonia superheating zone (23) and a fuel combustion zone (213) . . . . In the block flow diagram of FIG. 2 the ammonia cracking reactor (24), the ammonia superheating zone (23), and the fuel combustion zone (213) are all part of the same piece of equipment. Ammonia from the ammonia superheating zone (23) is fed to an ammonia cracking reactor (24) to produce a hydrogen containing stream. The hydrogen containing stream is fed to a steam generator (25) and to a heat recovery zone (26). The hydrogen containing stream from the heat recovery zone (26) is fed to a gas turbine (27) where it is combusted in the presence of an oxygen containing feed which is air (217) which has been compressed by a compressor (28). Steam from the steam generator (25) and a portion of the off-gas-gas from the gas turbine (27) are used to generate electrical power (210). A portion of the heat from the off-gas from the gas turbine (25) is recovered by a heat recovery steam generator (29). In the fuel combustion zone (213) ammonia fuel is combined with a portion of the oxygen containing off-gas from the gas-turbine (27). The ammonia fuel and the oxygen containing off-gas are combusted in the fuel combustion zone (213) to produce heat energy for the ammonia cracking reactor (24). Exhaust gas from the ammonia cracking reactor (24) is recovered in the heat recovery zone (214) and the exhaust gas sent to the stack (215) to be discharged as flue gas (216). Heat from the heat recovery zone (214) is used in the ammonia pre-heat & vaporisation zone (22) (not shown for clarity).

### Examples

To demonstrate the efficiency savings of the process of the invention, a simulation was performed comparing a flowsheet comprising an unintegrated gas turbine in accordance with FIG. 1 (not according to the invention) and a flowsheet comprising an integrated gas turbine in accordance with FIG. 2 (according to the invention).

For both flowsheets, the following assumptions were made:
The same ammonia cracking reactor and gas turbine were used for both flowsheets.
The energy requirements for the ammonia cracking reactors were met by the combustion of ammonia, with the total ammonia available for the entire system was set at 1200 metric tonnes per day (MTPD).
The inlet ammonia temperature to the cracker was 600° C.
The inlet ammonia temperature to the combustion side of the cracker was 90° C.
Ambient air temperature was 10° C.
Fuel requirements were set to achieve 0.58% ammonia slip for both flowsheets.
The flue gas from the HRSG was set to 280° C., and HPS was raised in the HRSG.

| | | Unintegrated | Integrated |
|---|---|---|---|
| | | system | system |
| | | (comparative | (according to |
| | Unit | example) | the invention) |
| Cracker feed | MTPD | 900 | 963 |
| ammonia | | | |
| Fuel ammonia | MTPD | 300 | 237 |
| Total ammonia | MTPD | 1200 | 1200 |
| Energy in | MW | 258 | 258 |
| ammonia* | | | |
| Air compressor | MW | −119 | −127 |
| power | | | |
| GT power | MW | 181 | 194 |
| HRSG power | MW | 29 | 27 |
| Net export** | MW | 91 | 94 |
| Net export | kW/te | 75.9 | 78.1 |
| per te NH₃ | | | |
| Energy efficiency*** | % | 35.3 | 36.3 |

*Total energy in all ammonia streams, based on LHV of ammonia being 316,449.8 kJ/kmol.
**The energy requirements for rotating equipment (excluding the air compressor) and the energy generated from steam generation through heat recovery of the cracked gas were not included in this analysis. Due to the higher exit temperature and higher flowrate of the cracked gas in the integrated system, the energy generated would be higher than the unintegrated system
***Based on the following formula:

$$Energy efficiency = \frac{\begin{matrix}Power output from GT + HRSG - \\ Power consumtpion of Air Compressor\end{matrix}}{Energy contained in feed \& fuel ammonia streams [ MW ]} * 100$$

The above simulations demonstrates that the system comprising an integrated gas turbine, according to the present invention, is more energy efficient and generates more electrical power for export per unit of ammonia fed to the system as compared to a non-integrated gas turbine.

1. A process for generating power using a gas turbine fueled by a carbon free fuel derived from the catalytic cracking of ammonia, the process comprising:
supplying an ammonia stream to an ammonia cracking reactor;
cracking the ammonia in the ammonia stream in the ammonia cracking reactor to produce a hydrogen containing stream;
combining the hydrogen containing stream with an oxygen containing feed and combusting the hydrogen containing stream with the oxygen containing feed to produce a combusted gas stream;
using the combusted gas stream to drive a gas turbine and produce an oxygen containing off-gas stream;
supplying at least a portion of the oxygen containing off-gas stream to a fuel combustion zone; and
combusting a fuel stream and the oxygen containing off-gas stream in the fuel combustion zone to produce heat energy for the ammonia cracking reactor.

2. The process according to claim 1, further comprising the step of pre-heating the ammonia stream to a temperature of from 350° C. to 1000° C.

3. The process according to claim 1, wherein the temperature of the ammonia stream at the inlet of the ammonia cracking reactor is in the range of 350° C. to 1000° C., from 400 to 950° C., from 450° C. to 850° C., or from 500° C. to 750° C.

4. The process according to claim 1, wherein the hydrogen containing stream comprises from 40 mol % to 75 mol % hydrogen.

5. The process according to claim 1, further comprising the step of feeding the hydrogen containing stream to a purification unit and increasing the hydrogen content of the hydrogen containing stream to produce a hydrogen-enriched stream and a tail gas.

6. The process according to claim 5, wherein the hydrogen-enriched stream comprises from 50 mol % to 100 mol % hydrogen.

7. The process according to claim 1, wherein the oxygen containing feed is a compressed oxygen containing feed.

8. The process according to a claim 1, wherein the oxygen containing feed is air, oxygen, or oxygen-enriched air.

9. The process according to claim 1, wherein the oxygen containing off-gas stream may comprise oxygen in an amount greater of from 5 mol % to 25 mol %.

10. The process according to claim 1, wherein the oxygen containing off-gas stream is supplied to the fuel combustion zone at a temperature of from 500° C. to 800° C., from 500° C. to 750° C., or from 600° C. to 700° C.

11. The process according to claim 1, wherein the portion of the oxygen containing off-gas stream supplied to the fuel combustion zone is from 5% to 75%, from 7% to 50%, from 8% to 30%, or from 9% to 20% of the total off-gas stream exiting the gas turbine.

12. The process according to claim 1, wherein the fuel stream comprises ammonia.

13. The process according to claim 1, wherein the fuel stream comprises ammonia in an amount of from 1 mol % to 100 mol % of the total fuel stream, preferably from 5 mol % to 75 mol %, from 10 mol % to 50 mol %, or from 15 mol % to 30 mol % of the total fuel stream.

14. The process according to claim 5, wherein the process comprises the step of feeding the tail gas to the fuel combustion zone; and combusting the fuel stream and the tail gas with the oxygen containing off-gas.

15. The process according to claim 1, wherein the fuel stream comprises one or more additional fuel sources selected from hydrogen, natural gas, methane, refinery off gas, biogas, the tail gas from the hydrogen purification unit, and a portion of the hydrogen containing stream from the ammonia cracking reactor.

16. The process according to claim 12, wherein the fuel stream comprises ammonia and the ammonia containing fuel stream is supplied from the same source as the ammonia stream being supplied to the ammonia cracking reactor.

17. The process according to claim 1, wherein the heat energy produced by combustion using the oxygen containing off-gas stream in the combustion zone provides more than 50% and up to 100% of the heat energy required by the ammonia cracking reactor.

18. A method for revamping an ammonia production facility, the method comprising the step of implementing the claim 1 in an ammonia production facility.
